(19) United States
(12) Patent Application Publication
(10) Pub. No.: US 2008/0191060 A1
(43) Pub. Date: Aug. 14, 2008

(54) Spray Gun

(76) Inventors: Hiroomo Kuwahara (Deceased), Hiroshima (JP); Shigemi Kuwahara, Hiroshima (JP)

Correspondence Address: MEREK, BLACKMON & VOORHEES, LLC, 673 S. WASHINGTON ST, ALEXANDRIA, VA, 22314, US

(21) Appl. No.: 10/573,483

(22) PCT Filed: Oct. 29, 2003
(86) PCT No.: PCT/JP03/13884

§ 371 Date: Feb. 13, 2007

(51) Int. Cl. B05B 7/02

(52) U.S. Cl. 239/526

(57) ABSTRACT

A spray gun allowing paint in atomized state to be jetted from a paint jetting part (3) provided in a body frame (5) by the operation of an operating member (6), wherein an air jetting means (4A, 4B) for forming a covering air flow surrounding the periphery of atomized paint jetted from the paint jetting part (3) are formed in the thick-walled part or internal space of the body frame (5), whereby the covering air flow can be formed by the air jetting means (4A, 4B) in connection with the operation of the operating member (6).

### TECHNICAL FIELD

The present invention relates to a spray gun allowing paint in an atomized state to be jetted.

### PRIOR ART

There exists a spray gun allowing paint in an atomized state to be jetted from a paint jetting part provided in a body frame by operation of an operating member. In addition, there exists a ring air jetting device, mounted on the spray gun, for allowing compressed air to be jetted. (For example, see Japanese Patents No. 2917019 and No. 2990604.)

When the spray gun with the ring air jetting device is used, a covering air flow formed by the ring air jetting device surrounds the periphery of the atomized paint flow jetted from the paint jetting part, thereby effectively preventing useless paint splash from causing pollution.

In such a case, the conventional ring air jetting device needs to be mounted on the body frame of the spray gun in use, and an operating member different from the operating member for jetting paint needs to be provided for jetting compressed air. Therefore, the conventional ring air jetting device is inconvenient to use, and besides, it takes time to remove paint adhered to details of the ring air jetting device and the spray gun after use.

The present invention aims to provide a spray gun for overcoming the above-mentioned trouble.

### SUMMARY OF INVENTION

The invention is constructed so that in a spray gun allowing paint in an atomized state to be jetted from a paint jetting part provided in a body frame by the operation of an operating member, an air jetting means for forming a covering air flow surrounding the periphery of atomized paint jetted from a paint jetting part is formed in a thick-walled part or internal space of the body frame, whereby the covering air flow can be formed by the air jetting means in connection with the operation of the operating member.

According to this, the covering air flow jetted from the air jetting means surrounds the periphery of the atomized paint flow jetted from the paint jetting part, thereby preventing the useless dispersion of paint due to wind and the pollution caused by the dispersion. The air jetting means is incorporated into the body frame in place of the conventional ring air jetting device, thereby saving trouble in mounting a different operating member on the spray gun. That is, the covering airflow can be formed by the operation of a single operating member. In addition, since the conventional ring air jetting device becomes unnecessary, the paint will never adhere to a ring air jetting device and in a space between a ring air jetting device and the body frame of the spray gun.

The above-mentioned invention can be embodied as follows. The invention is constructed so that, in the spray gun allowing paint in an atomized state to be jetted from the paint jetting part provided in the body frame by the operation of the operating member, an air jetting part for jetting compressed air for forming a covering air flow surrounding the periphery of atomized paint jetted from the paint jetting part, an air intake for taking compressed air fed from the outside, an air ventilation path for ventilating the compressed air taken from the intake, and an air valve for opening and closing the air ventilation path are provided in the thick-walled part or the internal space of the body frame, whereby an interlocking means for opening and closing the air valve can be provided in connection with the operation of the operating member.

According to this, effects like those mentioned above can be obtained. In addition, the compressed air taken from the air intake is jetted from the paint jetting part by the operation of the operating member.

In this case, for example, the paint jetting part is provided on the front part of a longitudinal part of the body frame, a longitudinal input bar member for opening and closing a paint valve part forming a part of the paint jetting part is provided behind the paint jetting part, and an air valve element forming a part of the air valve is provided behind the input bar member, whereby the input bar member can be displaced in connection with the operation of the operating member.

According to this, paint jetting from the paint jetting part due to release of the paint valve part and air jetting from the air jetting part due to release of the air valve can be started by the operation of the single operating member of a compact gun shape.

### BRIEF DESCRIPTION OF THE DRAWINGS

FIG. 1 is a perspective view of a spray gun according to the invention.

FIG. 2 is a side view of the main part of the spray gun.

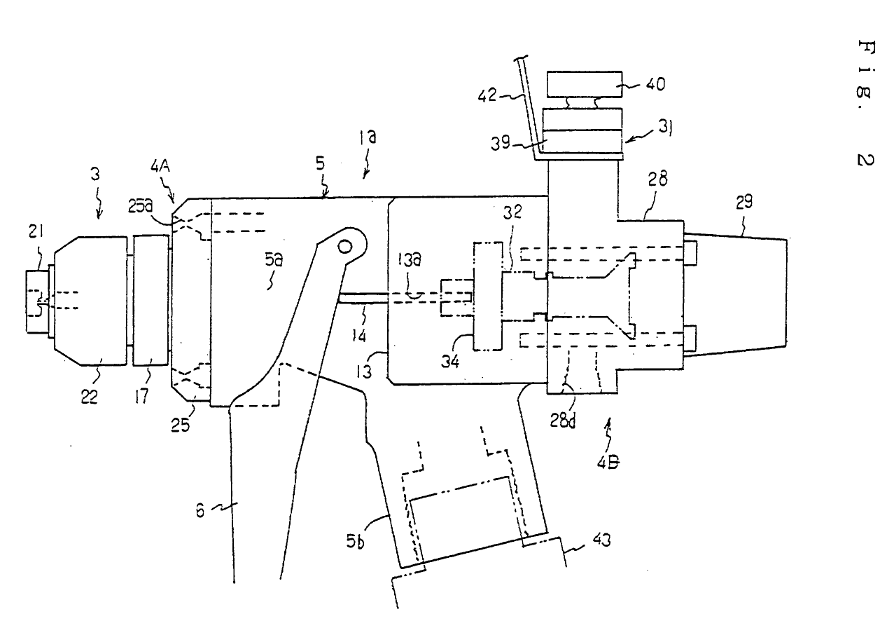

FIG. 3 is a cross section showing the internal construction of the main part.

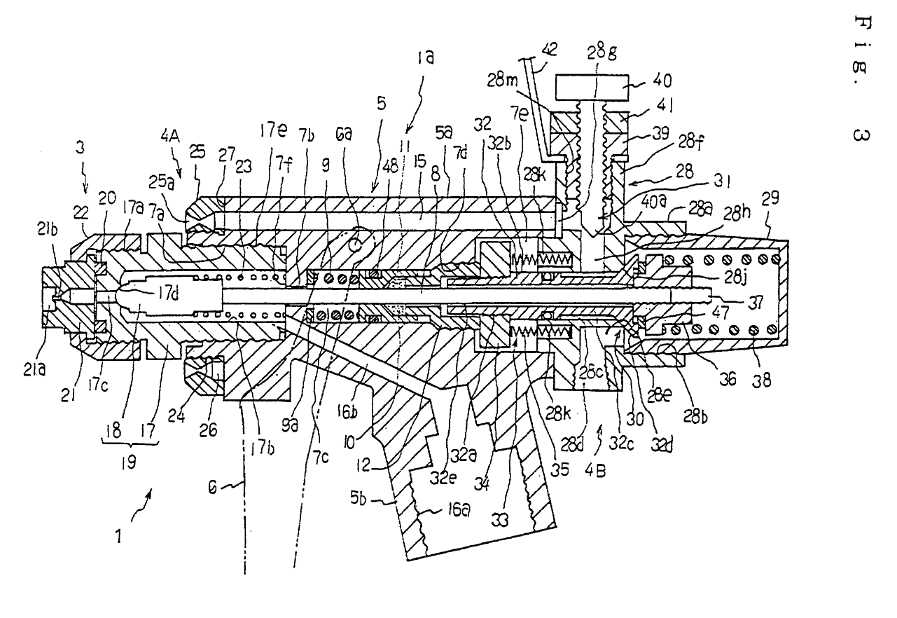

FIG. 4 is a partial enlarged view of a ring nozzle hole member of the main part of FIG. 3.

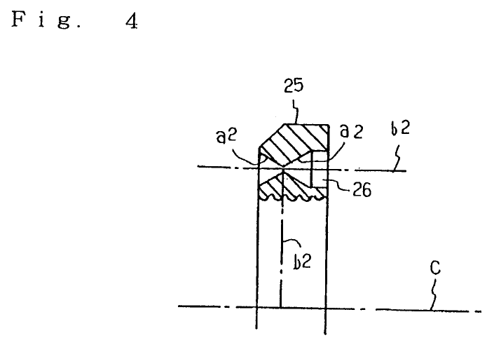

### PREFERRED EMBODIMENT OF THE INVENTION

A preferred embodiment of the present invention will be specifically explained according to the drawings as follows.

In the figures, 1 is a main important structural part extending comparatively long in a longitudinal direction, 2 is a bar prehension part extending downward from the underside of the main important structural part 1 in the longitudinal direction.

The main important structural part 1 comprises a central body part 1a. A paint jetting part 3 and a compressed air jetting part 4A are positioned on the front of the main important structural part 1, and a compressed air feeding part 4B is positioned on the rear thereof.

The central body part 1a comprises a body frame 5 having a longitudinal part 5a and a paint feeding part 5b. Besides, a lever operating member 6 is mounted at the center, in the longitudinal direction, of the upper part of the body frame 5 through a lateral spindle 6a.

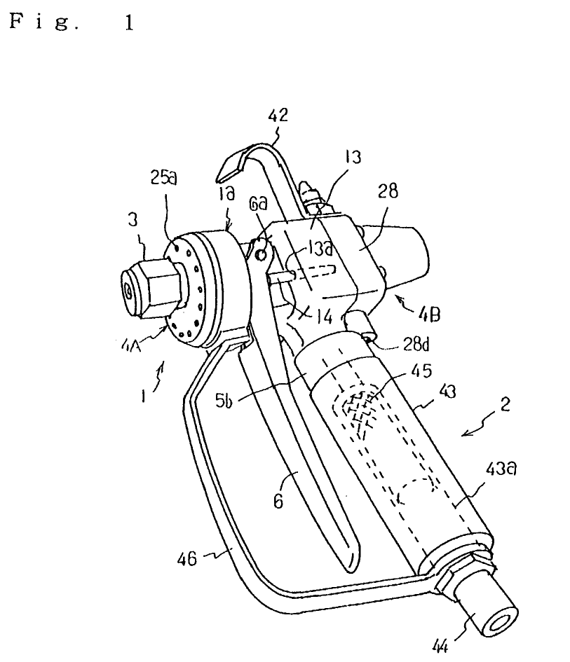

A plurality of uneven inner holes 7a, 7b, 7c, 7d, 7e are connectively formed inside the longitudinal part 5a, and therein, a straight longitudinal input bar member 8 is inserted displaceably in the longitudinal direction. The inner hole 7c is internally equipped with a cylindrical sliding member 11 for containing a spring receiving board 9a, a compressed coil spring 9 and a sealing member 10. A female thread is formed on the inside periphery of the central body part 1a at the inner hole 7d, and a sealing receive member 12 is screwed into the inner hole 7d. Lateral buckling members 13 are formed to left and right sides of the rear portion of the longitudinal part 5a. A guide hole 13a with a small diameter is formed to a lateral buckling member 13 so as to extend rearward from the front end as shown in FIG. 1. A small-diameter shaft member 14 is inserted in the guide hole 13a displaceably in a longitudinal direction. The front end of the small-diameter shaft member 14 is touched to the upper rear end of the side surface of the lever operating member 6. A straight air ventilation path 15 is formed to the top of the longitudinal part 5a almost over all length.

The paint feeding part 5b has an inner hole 16a with a female thread for communicating to the inner hole 7a through a comparatively slender-inclined inner hole 16b formed to the longitudinal part 5a.

The paint jetting part 3 comprises a paint valve part 19, a nozzle hole member 21, a nut member 22 and a compressed spring 23. The paint valve part 19 comprises a valve seat member 17 and a valve plug member 18. The nozzle hole member 21 comprises a cavity 21a and a nozzle hole 21b with a small diameter, arranged opposite to the front side of the valve seat member 17 through a ring packing 20. The nut member 22 is screwed on a front thread part 17a of the valve seat member 17 to push the nozzle hole member 21 to the front side of the valve seat member 17. The compressed spring 23 is arranged inside an inner hole 17b of the valve seat member 17 to push the valve plug member 18 to a ring contact surface 17d around a nozzle hole 17c of the valve seat member 17. In this case, a rear thread part 17e of the valve seat member 17 is screwed in the female thread of the inner hole 7a. The tip face of the valve plug member 18 forms a semi-spherical. The rear end of the compressed spring 23 is supported by a longitudinal face 7f positioned at the most interior of the female thread part of the inner hole 7a.

An air jetting part 4A is constructed so as to screw a ring nozzle hole member 25 on a male thread part 24 formed to the front end of the longitudinal part 5a. In this case, the nozzle hole member 25 has a female thread to be screwed in the male thread part 24 at the center and longitudinal nozzle holes 25a formed to the front surface of the ring at a fixed pitch of the circumferential direction. The rear end of each nozzle hole 25a is connected through a ring groove 26 formed to the rear. In this case, the nozzle hole 25a has a conical surface a1 whose diameter is reduced to the front and a conical surface a2 whose diameter is enlarged thereto connected so as to be arranged longitudinally. It is preferable that a central line b1 of the nozzle hole 25a is somewhat rotated and inclined around a radial line b2 corresponding to a parallel line of a longitudinal central line “c” of the nozzle hole member 25 in accordance with Japanese Patent No. 2917019. In addition, the ring groove 26 is airtightly covered with a front end 27 of the longitudinal part 5a positioned on the rear end of the male thread part 24, connected to the air ventilation path 15.

A compressed air feeding part 4B comprises a rear end frame 28, a cylindrical case 29, an air valve 30 and an airflow regulating part 31. Here, the rear end frame 28 is fixed to the rear end of the longitudinal part 5a. The cylindrical case 29 is screwed in a female thread formed to an inner hole 28a of a rear projecting part 28a of the rear end frame 28. The air valve 30 is formed inside the rear end frame 28, the cylindrical case 29 and the rear end of the longitudinal part 5a. The airflow regulating part 31 is formed to the upper part of the rear end frame 28.

In this case, the rear end frame 28 comprises a longitudinal central hole 28c, a square curved air inflow hole 28e and a square curved air ventilation hole 28h. The central hole 28c is communicated from the inner hole 7e to the inner hole 28b. The air inflow hole 28e is communicated from an air intake 28d formed to the bottom to the inner hole 28b. The air ventilation hole 28h is communicated from the central hole 28c to the air ventilation path 15 by way of a front opening 28g of an upper projecting part 28f.

The air valve 30 comprises a cylindrical air valve plug 32 inserted into the central hole 28c, a valve seat portion 28j formed to the rear end of the central hole 28c, and a valve plug energising means 33 for pushing the air valve plug 32 forward. Here, the air valve plug 32 is equipped with a male thread part 32a, a sliding contact surface part 32c for being inserted into the central hole 28c, a path contact surface part 32c having a diameter smaller than the sliding contact surface part 32b, and a rearward spreading taper surface part 32d on the periphery in order from the front. The valve plug energising means 33 comprises a disk member 34 screwed in the male thread part 32a, a spring support hole 28k formed near the periphery of the central hole 28c at the front of the rear end frame 28 at a fixed interval, and a compressed spring 35 provided between the rear of the disk member 34 and the bottom of the spring support hole 28k. In this case, the front of the disk member 34 is caught to the rear end of the small-diameter shaft member 14 to regulate the forward displacement of the air valve plug 32.

The air valve plug 32 has a longitudinal central hole 32e, and therein, the longitudinal input bar member 8 is inserted. In addition, a catching nut 36 is screwed on the thread part of the rear end of the input bar member 8 at the rear side of the air valve plug 32. A rock bolt 37 for connecting the input bar member 8 and the nut 36 is screwed in the rear portion of the thread hole of the nut 36. And a compressed spring 38 for pushing the input bar member 8 forward is mounted between a flange of the nut 36 and the rearward inner surface of the cylindrical case 29. The compressed spring 38 contributes to adjusting a force necessary for operating the lever operating member 6.

The air flow regulating part 31 comprises a catching bolt 39 for being fasteningly screwed in a longitudinal female thread part 28m formed to the upper projecting part 28f, an adjusting bolt 40 for being screwed in a female thread formed to the center of the bolt 39, and a rock nut 41 for fasteningly fixing the adjusting bolt 40 on the bolt 39. Here, the tip of the adjusting bolt 40 is formed as a conical surface 40a. Besides, a hock member 42 is fixed on the upper projecting part 28f through the catching bolt 39.

The bar prehension part 2 is equipped with a cylindrical member 43 for being screwed in the inner hole 16a of the paint feeding part 5b. A member 44 for connecting a not-illustrated paint feeding hose is fixed to the bottom of the central hole 43a of the cylindrical member 43. A central hole 44a includes a filter 45 for filtering impurities included in the paint passing therethrough.

Besides, 46 is a protecting case bent as shaped in L letter, which is fixed between the front lower part of the longitudinal part 5a and the connecting member 44 as shaped in a bridge. Numerals 47, 48 are sealing members, respectively.

Next, using examples and operations about the above-mentioned embodiment will be explained.

Before using, the paint feeding hose is connected to the connecting member 44, and a compressed air feeding hose is connected to the air intake.

In starting painting, the bar prehension part 2 is gripped and the lever operating member 6 is pulled to the side thereof with a finger.

The lever operating member 6 is rockably displaced rearward around the lateral spindle 6a, thereby pushing the front ends of the left and right small-diameter shaft members 14 rearward. In regard with this, the rear ends of the shaft members 14 push the input bar member 8 rearward through the disk member 34 against the flexibility of the compressed springs 35, 38.

A rearward displacement of the air valve plug 32 separates the taper surface part 32d and the valve seat portion 28j to open the air valve 30. Therefore, the compressed air arrived in the air intake 28d and the air inflow hole 28e flows into the central hole 28c. The compressed air arrived in the central hole 28c passes through the air ventilation hole 28h, a throttling space around the front of the adjusting bolt 40, thereafter powerfully jetting from each nozzle hole 25a forward.

The rearward displacement of the air valve plug 32 connectedly displaces the input bar member 8 rearward, thereby separating the valve member 18 and the ring contacting surface 17d to open the paint valve part 19. Therefore, pressure paint flows into the inner holes 16a, 16b, 17b, thereafter jetting through the nozzle holes 17c, 21b and the concave 21a, thereafter being atomized by friction to the outer air, flowing as a conical shape while the diameter is gradually enlarged to the front.

It is preferable that the paint is jetted from the paint jetting part 3 after the compressed air is started jetting from the air jetting part 4. The jetted atomized paint is hardly poured by wind of the environment because the periphery of the paint is covered with air flow in a fixed direction due to the compressed air jetting like the case of Japanese Patent No. 2917019. Further, since the atomized paint is stirred due to jetting of the compressed air, uniformity of the density of the paint is promoted. Besides, the paint density is effectively unified due to stirring the atomized paint, whereby nonuniformity can be prevented from occurring on the painted surface.

In the above-mentioned example, although the paint is jetted from the paint jetting part 3 by pressure energy of the paint fed into the inner hole 16b, the present invention is not be limited to this. It is expected that the paint is sucked from a paint can by compressed air energy like a spray gun of Japanese Patent No. 2990604 to be jetted from the paint jetting part 3.

Utility Possibility in Industry

According to the present invention, since the air jetting means is included inside the body frame, it is unnecessary to provide another one to a spray gun like the conventional ring air jetting device. Further, compressed air can be jetted only by the operation of the operating member for jetting the paint of the spray gun. Further, the paint adhered on the device can be easily removed.

The compressed air taken in from the air intake can be surely jetted from the paint jetting part by the operation of the operating member.

Jetting the paint from the paint jetting part and jetting the air from the air jetting part can be started by the operation of the only operating member. Accordingly, the spray gun can be formed compact and simple.

1. A spray gun allowing paint in an atomized state to be jetted from a paint jetting part in a body frame by operation of an operating member,
wherein air jetting means for forming a covering air flow surrounding the periphery of atomized paint jetted from the paint jetting part is formed in a thick-walled part or internal space of the body frame, whereby the covering air flow can be formed by the air jetting means in connection with the operation of the operating member.

2. A spray gun allowing paint in an atomized state to be jetted from a paint jetting part in a body frame by operation of an operating member,
wherein an air jetting part for jetting compressed air for forming a covering air flow surrounding the periphery of atomized paint jetted from the paint jetting part, an air intake for receiving external compressed air, an air ventilation path for flowing the compressed air from the air intake to the air jetting part, and an air valve for opening and closing the air ventilation path are provided in a thick-walled part or internal space of the body frame, whereby interlocking means for opening and closing the air valve can be provided in connection with operation of the operating member.

3. A spray gun according to claim 2, wherein said paint jetting part is provided on the front part of a longitudinal part of said body frame, a longitudinal input bar member for opening and closing a paint valve part forming a part of the paint jetting part is provided behind the paint jetting part, and an air valve element forming a part of the air valve is provided behind the input bar member, whereby the input bar member can be displaced in connection with the operation of the operating member.
